(19) United States
(12) Patent Application Publication
(10) Pub. No.: US 2008/0049698 A1
(43) Pub. Date: Feb. 28, 2008

(54) Method of Controlling Power in a W-Cdma Mobile Communication System

(76) Inventor: Dong Keun Kim, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/569,046

(22) PCT Filed: Sep. 24, 2004
(86) PCT No.: PCT/KR04/02470

§ 371 Date: Apr. 23, 2007

(30) Foreign Application Priority Data
Sep. 30, 2003 (KR) 10-2003-0067737

(51) Int. Cl. H04B 7/216

(52) U.S. Cl. 370/342

(57) ABSTRACT

The present invention is related to a backward outer-loop power control method in a wideband CDMA mobile communication system for improving backward call quality and capacity of an IMT-2000 asynchronous system. In accordance with the present invention, the power control is optimized by examining the field transmitted through the backward Dedicated Physical Control Channel (DPCCH), as well as the CRC examination of the uplink data frame received, thus setting the optimum target SIR.

### TECHNICAL FIELD

The present invention generally relates to a backward outer-loop power control method, and more particularly to a backward outer-loop power control method in a wideband CDMA mobile communication system for improving backward call quality and capacity of an IMT-2000 asynchronous system.

### BACKGROUND ART

Generally, a CDMA system uses forward (from a base station to a mobile) and backward (from a mobile to a base station) power control to obtain large capacity, good call quality and so on. The objective of the transmission power control of mobile units is that a receiver of the base station receives every signal of nominal intensity from the mobile units. Regardless of the positioning of the mobile units and propagation loss, the transmitting signals of each mobile unit need to be received at the same intensity. If every transmission power of mobile units in an area is controlled similar to the above, then the total received power is the multiplication of the nominal received power and the number of the mobile units.

There are three types of power control: open-loop power control, closed-loop (inner-loop or fast), and outer-loop power control. Among them, the outer-loop power control set a target Signal-to-Interference Ratio reference value (hereinafter, “SIR_{Target}”) that is used for the closed-loop power control to a desired standard value of the call quality. That is, the outer-loop power control does not fix the SIR_{Target} value to a specific value, but varies the SIR_{Target} to maintain a BLER measured at every certain time period at a target BLER according to the communication environment.

FIG. 1 shows a structure of an UMTS Terrestrial Radio Access Network (UTRAN) in a typical WCDMA mobile communication system.

Reference numeral 100 designates a core network, reference numeral 200 designates a UTRAN, and reference numerals 210 and 220 designate RNSs, which play the role of base stations/control stations. Further, reference numeral 211 designates a Radio Network Controller (RNC) in the RNS, reference numerals 212 and 213 designate Node-B connected to the RNS, and reference numeral 300 designates an User equipment (UE) (UE) such as a mobile unit.

The conventional closed-loop power control, which produces instruction bits for Transmit Power Control (TPC) in the backward transmission, is performed at Node-Bs in FIG. 1. The conventional outer-loop power control is performed at Radio Network Controllers (RNCs).

To set the SIR_{Target} of the base station, RNC 211 is informed whether a frame error exists by examining Cyclic Redundancy Checksum (CRC) in received data frames at Node-B. The SIR_{Target} is set according to the error existence of the frame.

FIG. 4 is a flow chart showing the outer-loop power control method in a conventional WCDMA mobile communication system.

As shown in the drawing, the method comprises the steps of: initializing parameters (S11); setting a SIR_{Target} and a target Block Error Rate (BLER) (S12); estimating a received SIR (S13); comparing the estimated SIR with the SIR_{Target} (S14); instructing a user equipment (UE) (UE) to lower transmission power if the estimated SIR is greater than the SIR_{Target} (S15); lowering the transmission power at the user equipment (UE) (S16); instructing the user equipment (UE) (UE) to raise the transmission power if the estimated SIR is not greater than the target SIR (S17); raising the transmission power at the user equipment (UE) (UE) (S18); checking if an uplink frame is received (S19); checking if received data has any frame error in case the uplink frame has been received (S20); lowering the SIR_{Target} by a predetermined value when it is determined that the received data has no frame error (S21); raising the target SIR if it is determined that a pilot error has occurred according to the result of the pilot error check (S22).

More detailed explanation on the outer-loop power control method in a conventional WCDMA mobile communication system is provided below.

First, at step S11, parameters are initialized. At step S12, the SIR_{Target} and the target BLER are set. Then, at step S13, the received SIR is estimated. At step S14, the estimated SIR and the target SIR are compared each other.

After the two values are compared, if the estimated SIR is greater than the SIR_{Target}, then the control is transferred to step S15, where the user equipment (UE) is instructed to lower the transmission power. Upon receiving such instruction, the user equipment (UE) lowers the transmission power at step S16. Further, after the two values are compared, if the estimated SIR is not greater than the SIR_{Target}, then the control is transferred to step S17, where the user equipment (UE) is instructed to raise the transmission power. Upon receiving such instruction, the user equipment (UE) raises the transmission power at step S18.

Then, it is checked if an uplink frame is received at step S19. If the uplink frame has been received, then it is checked if the received data has any frame error by examining CRC of the transmitted data [the data transmitted in backward Dedicated Physical Data Channel (DPDCH)] at step S20. The SIR_{Target} is lowered at step S21 when it is determined that the received data has no frame error. Otherwise, the SIR_{Target} is raised at step S22 when it is determined that the received data has a frame error.

More specifically, in the conventional outer-loop power control method, to set SIR_{Target}, the RNC is informed whether any frame error exists by examining Cyclic Redundancy Checksum (CRC) in the received data frames at Node-B. The SIR_{Target} is set according to the target BLER.

Because many mobile units and base stations use the same frequency channel simultaneously and interferences among the mobile units that use the same frequency channel increases in the CDMA mobile communication, the call quality worsens. The system capacity is maximized when the mobile units transmit power with the minimum Signal-to-Interference Ratio by control over all the mobile units.

The key factor to the call quality that the user undergoes is determined not by the SIR, but by the BLER. In an area where fading is severe, the BLER may be low even though the SIR is high. In a line of sight area between a base station and a mobile unit, the BLER may be high even though the SIR is low.

However, the conventional power control method is disadvantageous in that mobile units that output unnecessary power decrease the call quality of others or itself and the system capacity. This is because the conventional method controlled the outer-loop power with the SIR only, and thus cannot set an SIR corresponding to the target BLER.

### DISCLOSURE OF INVENTION TECHNICAL PROBLEM

Accordingly, the present invention is provided to solve the above-described problems of the prior art. The objective of the present invention is to provide a backward outer-loop power control method in a wideband CDMA mobile communication system for improving backward call quality and capacity of an IMT-2000 asynchronous system.

### TECHNICAL SOLUTION

In accordance with the present invention, the power control is optimized by examining the field transmitted through the backward Dedicated Physical Control Channel (DPCCH), as well as the CRC examination of the uplink data frame received, thus setting the optimum SIR_{Target}.

### BRIEF DESCRIPTION OF THE DRAWINGS

The above objective and features of the present invention will become more apparent from the following description of the preferred embodiment provided in conjunction with the accompanying drawings.

FIG. 1 is a block diagram showing a structure of UTRAN in a general WCDMA system.

FIG. 2 shows a structure of a general backward DPDCH/DPCCH.

FIG. 3 shows a structure of a backward data frame in a general frame protocol.

FIG. 4 is a flow chart showing an outer-loop power control method in the conventional WCDMA mobile communication system.

FIG. 5 is a flow chart showing a backward outer-loop power control method in the WCDMA mobile communication system according to an embodiment of the present invention.

FIG. 6 shows a structure of a backward DPCCH frame.

FIG. 7 shows a pilot pattern of a backward DPCCH channel when N_pilot is 3, 4, 5 and 6.

FIG. 8 shows a pilot pattern of a backward DPCCH channel when N_pilot is 7 and 8.

FIG. 9 is a flow chart showing patterns of error occurrence examined by CRC and a pilot field.

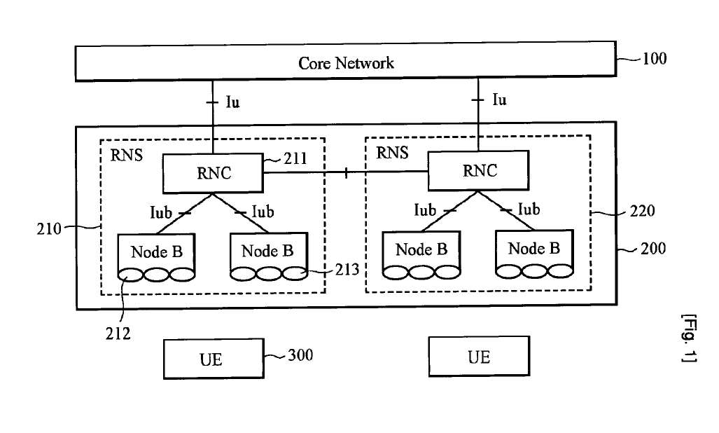

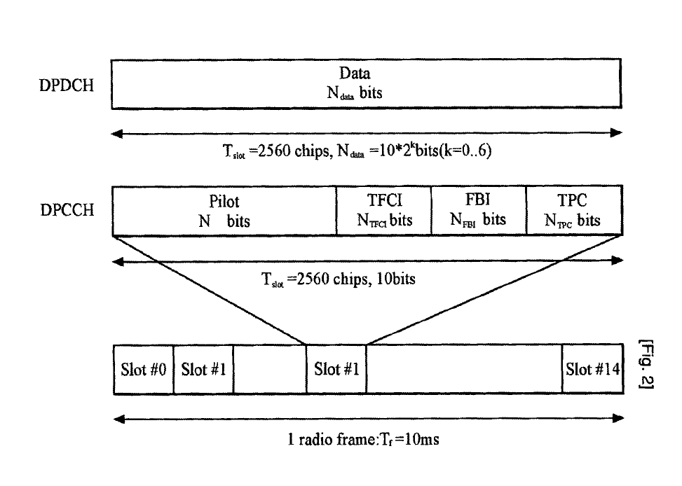

### BEST MODE FOR CARRYING OUT THE INVENTION

An embodiment of the present invention is described in detail in the following description with reference to the appended drawings.

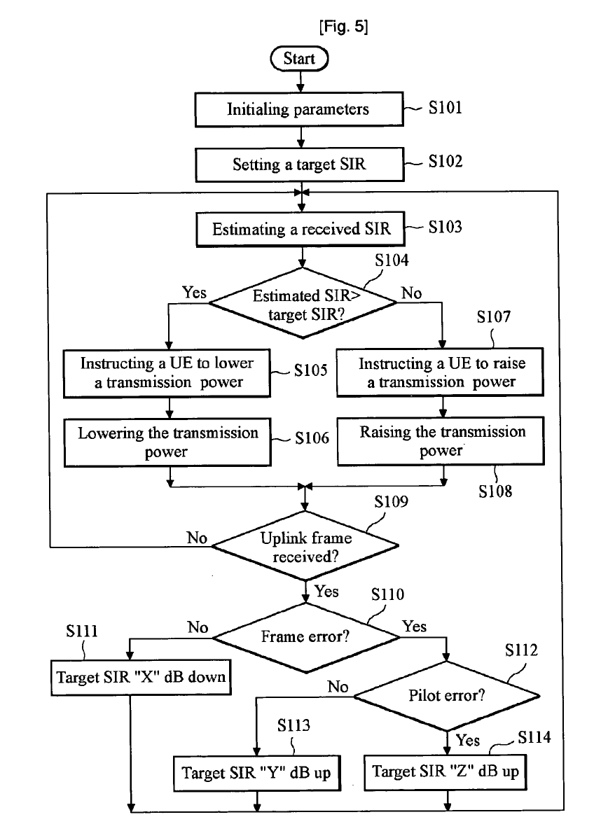

FIG. 5 is a flow chart showing the outer-loop power control method in a WCDMA mobile communication system.

As shown in the drawing, the method according to an embodiment of the present invention comprises the steps of: initializing parameters (S101); setting a SIR_{Target} (S102); estimating a received SIR (S103); comparing the estimated SIR with the SIR_{Target} (S104); instructing a user equipment (UE) (UE) such as a mobile unit to lower a transmission power if the estimated SIR is greater than the SIR_{Target} (S105); lowering the transmission power at the user equipment (UE) (UE) (S106); instructing the user equipment (UE) (UE) to raise the transmission power if the estimated SIR is not greater than the SIR_{Target} (S107); raising the transmission power at the user equipment (UE) (UE) (S108); checking if an uplink frame is received (S109); checking if received data has any frame error in case uplink frame have been received (S110); lowering the SIR_{Target} by a predetermined value (“X” dB) when it is determined that the received data has no frame error (S111); checking if a pilot error has occurred in case a frame error was found in the received data (S112); raising the SIR_{Target} by a first predetermined value (“Y” dB) if it is determined that no pilot error has occurred according to the result of the pilot error check (S113); and raising the SIR_{Target} by a second predetermined value (“Z” dB), which is greater than the first predetermined value (“Y” dB), if it is checked that a pilot error has occurred according to the result of the pilot error check (S114).

More detailed explanation on the outer-loop power control method in a WCDMA mobile communication system according to the embodiment of the present invention is provided below.

First, at step S101, parameters are initialized. At step S102, the SIR_{Target} is set. The SIR_{Target} is set as the one that is set last time and at the time of system initialization, the SIR_{Target} is set to a predetermined value. Then, at step S103, the received SIR is estimated. At S104, the estimated SIR and the SIR_{Target} are compared each other.

After the two values are compared, if the estimated SIR is greater than the SIR_{Target}, the control is transferred to step S105, where the user equipment (UE) is instructed to lower the transmission power. Upon receiving the instruction, the user equipment (UE) lowers the transmission power at step S106. Further, after the two values are compared, if the estimated SIR is not greater than the SIR_{Target}, then the control is transferred to step S107, where the user equipment (UE) is instructed to raise the transmission power. Upon receiving the instruction, the user equipment (UE) raises the transmission power at step S108. Then, it is checked if an uplink frame is received at step S109. In case the uplink frame has been received, it is checked if received data has any frame error by examining CRC of the transmitted data [the data transmitted in backward Dedicated Physical Data Channel (DPDCH)] at step S110.

The SIR_{Target} is lowered by a predetermined value (“X” dB) at step S111 when it is determined that the received data has no frame error. A pilot field is examined at S112 in case a frame error is found in the received data. The SIR_{Target} is raised by a first predetermined value (“Y” dB) at step S113 if it is determined that no pilot error has occurred according to the result of the pilot error check. Otherwise, the SIR_{Target} is raised by a second predetermined value (“Z” dB), which is greater than the first predetermined value (“Y” dB), at step S114 if it is determined that a pilot error has occurred according to the result of the pilot error check.

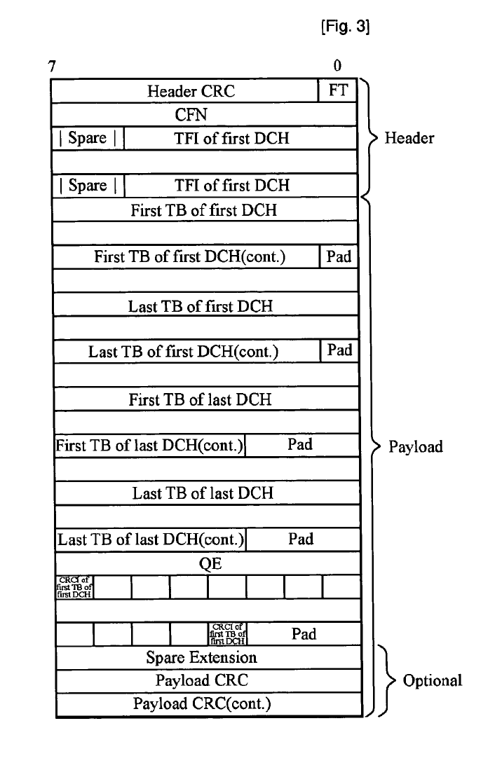

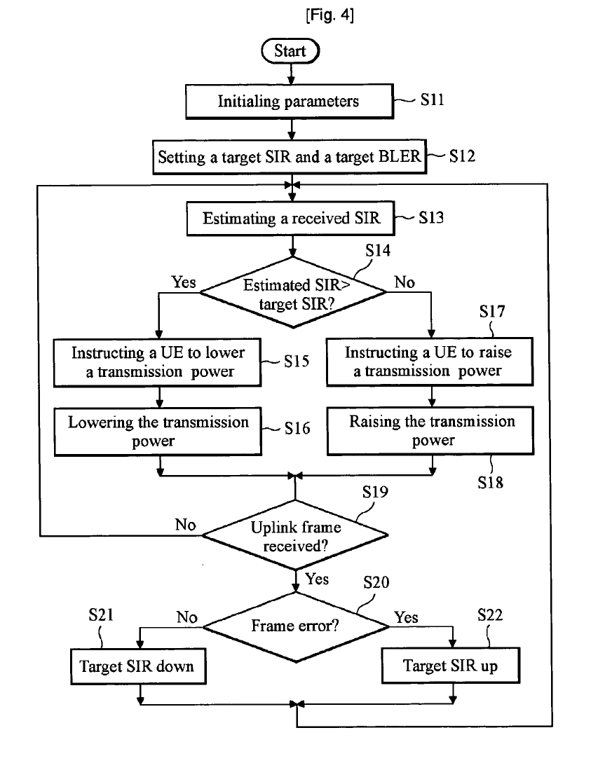

That is, the embodiment of the present invention determines if the received frame has an error by examining the CRC of the backward DPDCH frame in channel card of Node-B to set SIR_{Target}. The result of the CRC examination is informed to RNC by “CRCI” field shown in FIG. 3, which is a backward data frame of frame protocol defined in the standard.

SIR_{Target} set by the outer-loop power control in FIG. 5 is transmitted to Node-B by “UL Outer loop power control” frame in the frame protocol. This is to maintain the target BLER according to the error existence of the frame that is received by the “CRCI” field in FIG. 3.

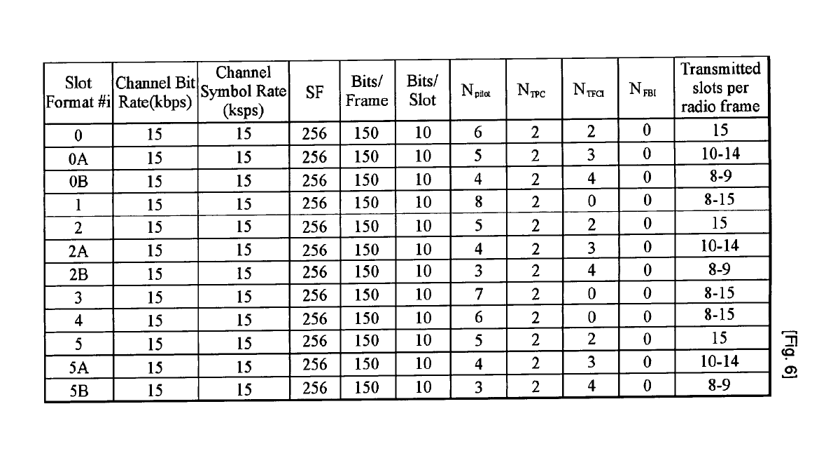

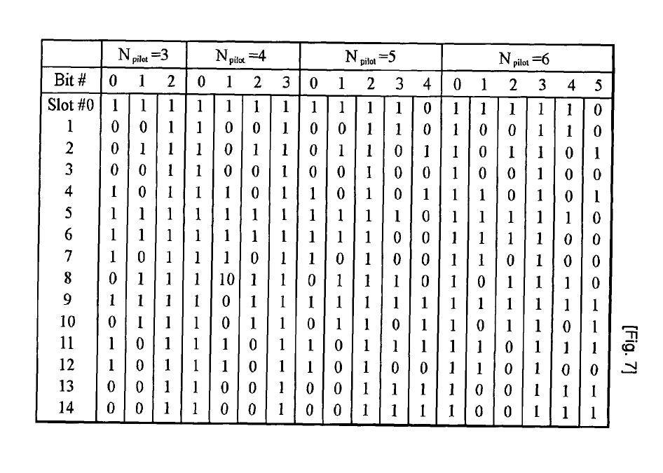

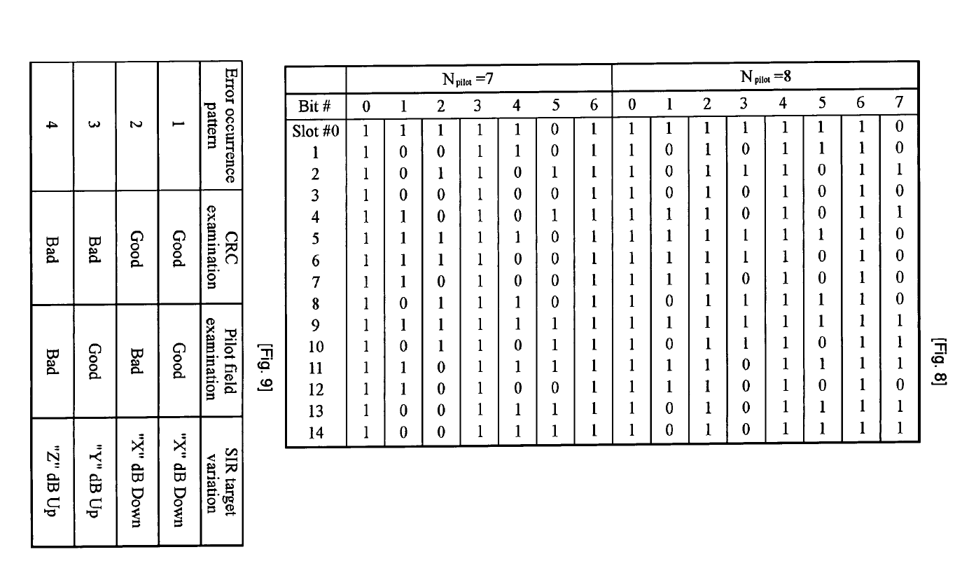

In the embodiment of the present invention, the error existence of the DPCCH frame through the examination of the backward DPCCH pilot field, as well as the result of the CRC examination of the DPDCH frame, is used for the outer-loop power control. The information on the error existence on the pilot field is informed to RNC by “Spare Extension” field in FIG. 3, and thus is used as a value to set the SIR_{Target}. The error existence of the pilot field can be determined by comparing the received pilot fields to the pilot patterns in FIGS. 7 and 9 according to the slot format of FIG. 6.

The reason for lowering the SIR_{Target} according to the error existence of the CRC and the pilot field is that the call quality felt by the user is determined by the target BLER through examination of the CRC in the data transmitted by the DPDCH channel.

Further, the reason for raising the SIR_{Target} to a different value is as follows. Higher gain is applied to the backward DPCCH channel to reduce the errors because it transmits control data of the DPDCH channel. Therefore, the channel environment of pattern 4 is worse than that of pattern 3. To compensate the difference of the channel environments, the SIR_{Target} is adjusted according to the channel environment by setting the second predetermined value (“Z” dB) greater than the first predetermined value (“Y” dB).

Although the present invention has been described in considerable detail with reference to certain preferred versions thereof, other versions are possible. Therefore, the scope of the appended claims should not be limited to the description of the preferred versions contained therein.

1. A method of controlling power in a W-CDMA mobile communication system, the method comprising the steps of:
estimating a Signal-to-Interference Ratio (SIR) after initializing parameters and setting a target SIR;
comparing the estimated SIR with the target SIR;
instructing a user equipment (UE) to lower transmission power if the estimated SIR is greater than the target SIR;
instructing the user equipment (UE) to raise the transmission power if the estimated SIR is not greater than the target SIR;
checking if received data has any frame error in case uplink data has been received;
lowering the target SIR by a predetermined value when it is determined that the received data has no frame error;
raising the target SIR by a first predetermined value (“Y”) if it is determined that no pilot error has occurred in case a frame error was found in the received data; and
raising the target SIR by a second predetermined value (“Z”) if it is determined that a pilot error has occurred in case a frame error was found in the received data.

2. The method according to claim 1, wherein the second predetermined value is greater than the first predetermined value.
